(19) United States
(12) Patent Application Publication
(10) Pub. No.: US 2022/0203763 A1
(43) Pub. Date: Jun. 30, 2022

(54) HUB LOCK NUT ASSEMBLY

(71) Applicant: Volvo Truck Corporation, Göteborg (SE)

(72) Inventors: Ramachandran SANDRASEKARAN, Bangalore, Karnataka (IN); Kent AUGUSTSSON, Bollebygd (SE); Tobias ANDERSSON, Torslanda (SE)

(21) Appl. No.: 17/605,137

(22) PCT Filed: Apr. 29, 2019
(86) PCT No.: PCT/EP2019/060964

§ 371 Date: Oct. 20, 2021

(51) Int. Cl. B60B 27/06; F16B 39/284; F16B 39/38

(52) U.S. Cl. CPC B60B 27/065; B60Y 2200/14; F16B 39/38; F16B 39/284

(57) ABSTRACT

A hub lock nut assembly for retaining a vehicle wheel hub in position. The hub lock nut assembly comprises a hub lock nut and a mating component. The hub lock nut comprises a circumferential inner wall defining a central hole, the inner wall having a threaded portion separated into a first section and a second section by an annular groove, thereby configuring the second section as a resilient portion arranged to flex with respect to the first section in an axial direction. The mating component comprises an inner wall defining a central hole extending in the axial direction, an annular end surface, and a protrusion on the annular end surface. The protrusion is configured to exert a force on the second section of the hub lock nut threaded portion, in the axial direction, when in the mated position, thereby retaining the vehicle wheel hub in position.

### TECHNICAL FIELD

The present disclosure relates to hub lock nut assemblies for holding a wheel hub in position.

The invention can be applied in heavy duty vehicles, such as trucks, buses, recreational vehicles and construction equipment.

### BACKGROUND

A wheel hub assembly, also sometimes referred to as a hub assembly, wheel hub unit or wheel hub bearing, is an automotive part used in many vehicle types such as trucks and semi-trailers. A wheel is attached to the wheel hub assembly by bolts. A roller bearing between the axle hub and axle shaft ensures easy rotation of the wheels.

The wheel hub assembly comprises a hub lock nut, which is a safety component that retains the wheel end in its position. It is important that the hub lock nut is properly tightened such that the wheel does not detach from the wheel hub assembly. The hub lock nut must also provide a prevailing torque to prevent loosening of the hub lock nut which holds the wheel hub in position.

GB 2508620 A discloses a locknut assembly comprising a lock nut configured to be mated with a compression washer in a mated position.

There is a need for improved hub lock nut assemblies.

### SUMMARY

It is an object of the present disclosure to provide improved hub lock nut assemblies.

This object is obtained by a hub lock nut assembly for retaining a vehicle wheel hub in position. The hub lock nut assembly comprises a hub lock nut and a mating component with which the hub lock nut is arranged to be mated in a mated position. The hub lock nut comprises a circumferential inner wall defining a central hole. This inner wall has a threaded portion separated into a first section and a second section by an annular groove in the threaded portion, thereby configuring the second section as a resilient portion arranged to flex with respect to the first section in an axial direction. The mating component comprises an inner wall defining a central hole extending in the axial direction and matching the central hole of the hub lock nut. The mating component comprises an annular end surface facing in the axial direction, wherein a protrusion is arranged on the annular end surface adjacent to the central hole. The protrusion is configured to exert a force F on the second section of the hub lock nut threaded portion, in the axial direction, when in the mated position, thereby retaining the vehicle wheel hub in position.

This hub lock nut assembly provides a robust prevailing torque function and enables an efficient wheel hub assembly process. The prevailing torque function is provided by the hub lock nut and the safety washer, and does not require modifications to the spindle, which is an advantage. The hub lock nut can be manufactured in a cost efficient manner by simply machining the groove into existing nuts of suitable dimension.

According to aspects, a width of the second section of the hub lock nut threaded portion in the axial direction corresponds to between two and three times a pitch or lead of the threaded portion. This range of widths provides a desired resilience property of the resilient portion. The width is large enough such that the resilient portion is robust, yet flexible enough to act as resilient portion.

According to aspects, a width of the annular groove in the axial direction is between 0.8 and 1.2 times a pitch or lead of the threaded portion, and preferably 1.0 times the pitch or lead of the threaded portion. This range of widths allows the second section of the hub lock nut threaded portion to flex sufficiently, while not weakening the threaded portion too much.

According to aspects, a depth of the annular groove is between 5 mm and 10 mm. This range of depths provide the required resilience property of the second portion.

According to aspects, the protrusion extends annually around the whole annular end surface of the mating component. This means that the pressure exerted by the mating component is evenly distributed around the whole hub lock nut, which is an advantage.

According to aspects, the external force is configured to provide a prevailing torque of the hub lock nut assembly in dependence of the hub lock nut dimension, wherein the prevailing torque varies between 50 Nm and 230 Nm. It is an advantage that the prevailing torque can be configured in dependence of hub lock nut dimension, since different dimensions of locking nuts often require different prevailing torque values.

According to aspects, any of the hub lock nut and/or the mating component is integrally formed by hot-formed steel. Thus, advantageously, the disclosed hub lock nuts and mating components can be manufactured in a cost efficient manner.

There are also disclosed herein hub lock nuts, safety washers, spindles, wheel hubs and vehicles associated with the above-mentioned advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

With reference to the appended drawings, below follows a more detailed description of embodiments of the invention cited as examples. In the drawings:

FIG. 1 illustrates a vehicle;

FIG. 2 schematically illustrates a wheel hub assembly;

FIG. 3 shows an example hub lock nut;

FIG. 4 shows an example mating component; and

FIGS. 5-6 schematically illustrate details of a hub lock nut assembly.

### DETAILED DESCRIPTION OF EXAMPLE EMBODIMENTS OF THE INVENTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

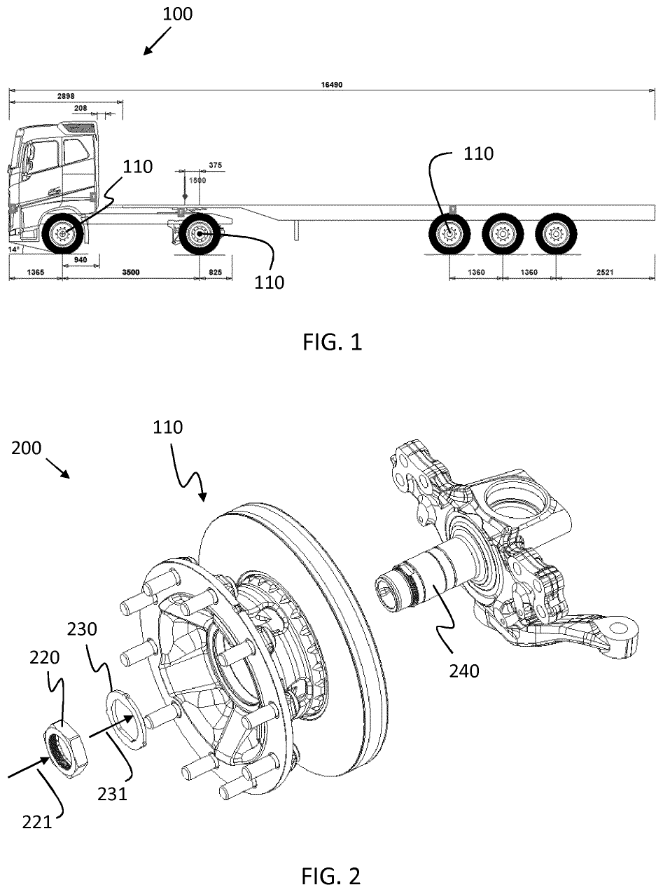

FIG. 1 schematically illustrates a vehicle 100 with vehicle wheel hubs 110 holding the wheels of the vehicle in position.

FIG. 2 schematically illustrates one such wheel hub assembly 110. A hub lock nut 220 is used to secure the vehicle wheel hub 110 to the spindle 240. Often, a safety washer 230 is arranged between the hub lock nut 220 and the wheel hub 110. It is desired to lock the wheel hub in position by using a hub lock nut assembly configured to provide a prevailing torque according to some given specification. Wheel hubs such as the wheel hub 110 schematically illustrated in FIG. 2 are known in general and will therefore not be discussed in detail here.

The present disclosure relates to a hub lock assembly adapted to provide a required prevailing torque. Prevailing torque differentiates a locknut from a free spinning nut based on a value of how much torque is required during installation before clamp loading. For example, on a nylon-insert nut, it is the torque needed to overcome the resistance of the nylon dragging across the mating thread. This torque value is usually not very high relative to final installation torque. Tolerance ranges for torque are specified in some standards such as ISO, DIN, IFI, ASME, SAE, AN-, MS-, NAS- NASM-.

Herein, lead is the distance along a screw's or bolt's axis that is covered by one complete rotation of the screw or bolt. Pitch is the distance from the crest of one thread to the next. Because the vast majority of screw threadforms are single-start threadforms, their lead and pitch are the same. Single-start means that there is only one “ridge” wrapped around the cylinder of the screw's body. Each time that the screw's body rotates one turn, it has advanced axially by the width of one ridge. “Double-start” means that there are two “ridges” wrapped around the cylinder of the screw's body. Each time that the screw's body rotates one turn, it has advanced axially by the width of two ridges. Another way to express this is that lead and pitch are parametrically related, and the parameter that relates them, the number of starts, very often has a value of 1, in which case their relationship becomes equality. In general, lead is equal to pitch times the number of starts. Herein, without loss of generality, single-start threads are assumed throughout.

Whereas metric threads are usually defined by their pitch, that is, how much distance per thread, inch-based standards usually use the reverse logic, that is, how many threads occur per a given distance. Thus, inch-based threads are defined in terms of threads per inch (TPI). Pitch and TPI describe the same underlying physical property—merely in different terms.

The present disclosure builds on a type of hub lock nut which has a groove machined into the threaded portion. This groove divides the threaded portion into two parts. The part closest to the wheel hub is made relatively narrow so as to form a resilient portion able to flex axially when subject to a pressure force. When this resilient portion flexes, friction increases between the threads on the narrow portion and the corresponding threads on the spindle. This increased friction provides a prevailing toque function in a convenient and cost effective manner.

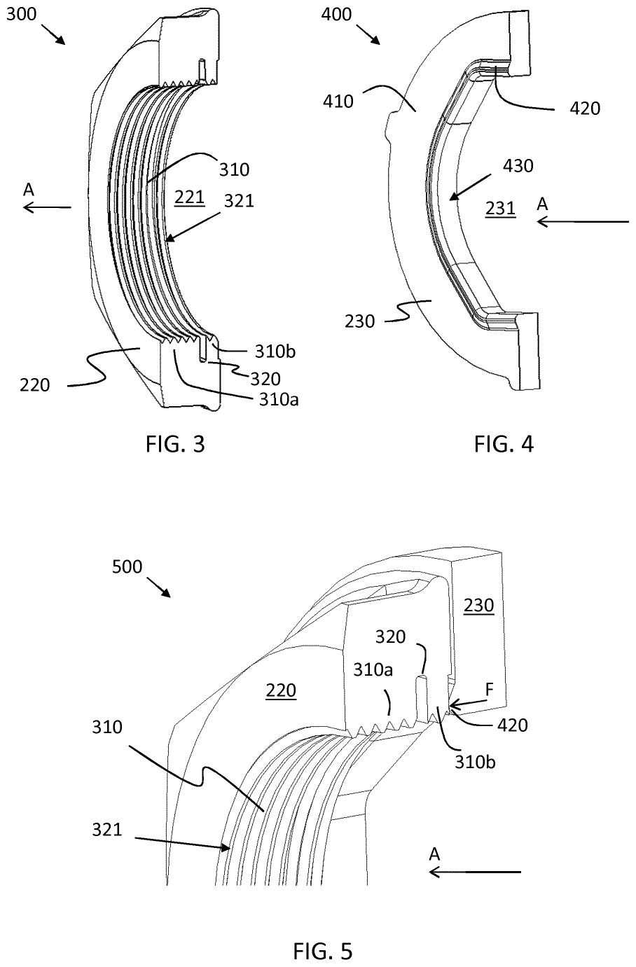

FIG. 3 shows an example hub lock nut 220 according to the present disclosure. The hub lock nut 220 comprises a circumferential inner wall 321 defining a central hole 221. The inner wall 321 has a threaded portion 310 separated into a first section 310a and a second section 310b by an annular groove 320 in the threaded portion 310, thereby configuring the second section 310b as a resilient portion arranged to flex with respect to the first section 310a in an axial direction A, as discussed above. The hub lock nut 220 is arranged to be threaded onto the spindle and held in position by the prevailing torque.

FIG. 4 shows an example mating component 230 according to the present disclosure. The mating component 230 is here a safety washer comprising an inner wall 430 defining a central hole 231 extending in the axial direction A and corresponding to the central hole 221 of the hub lock nut 220. The mating component 230 comprises an annular end surface 410 facing in the axial direction A. A protrusion 420 is arranged on the annular end surface 410 close to the central hole 231. This protrusion 420 is configured to exert a force F on the second section 310b of the hub lock nut 220 threaded portion 310, in the axial direction A, when in the mated position, thereby retaining the vehicle wheel hub 110 in position.

FIG. 5 schematically illustrates the hub lock nut 220 and the mating component 230 in or close to the mating position, i.e., when the prevailing force is generated or is just about to be generated. The protrusion 420 on the mating component 230 is here shown to push against the side of the hub lock nut 220. This push forces the second section of the threaded portion to flex inwards axially by the force F. The inwards flexing squeezes the groove 320 as the hub lock nut 220 is threaded onto the spindle 240.

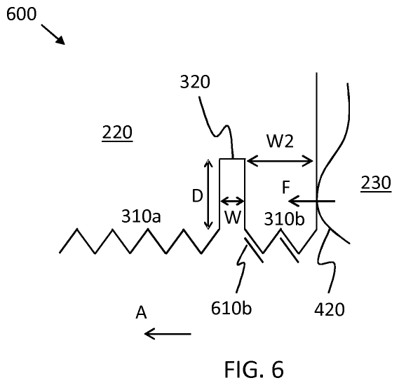

FIG. 6 schematically illustrates the effects of applying pressure axially to the second section 310b of the threaded portion 310. The squeezing applies pressure between the threads of the second section 310b and the corresponding threads of the spindle 610b. This generates friction which in turn provides the required prevailing torque.

The hub lock nut and the safety washer may advantageously be manufactured using hot-formed steel.

To summarize, with reference to FIGS. 3-6, there is disclosed herein a hub lock nut assembly 300, 400, 500, 600 for retaining a vehicle wheel hub 110 in position. The hub lock nut assembly comprises a hub lock nut 220 and a mating component 230 with which the hub lock nut 220 is arranged to be mated in a mated position. The hub lock nut 220 comprises a circumferential inner wall 321 defining a central hole 221. Notably, the inner wall 321 has a threaded portion 310 separated into a first section 310a and a second section 310b by an annular groove 320 in the threaded portion 310, thereby configuring the second section 310b as a resilient portion arranged to flex with respect to the first section 310a in an axial direction A. In other words, the inner wall 321 has a threaded portion 310 separated into a first section 310a and a second section 310b by an annular groove 320 in the threaded portion 310, such that the second section 310b is a resilient portion arranged to flex with respect to the first section 310a in an axial direction A.

The mating component 230 comprises an inner wall 430 defining a central hole 231 extending in the axial direction A corresponding to the central hole 221 of the hub lock nut 220. The mating component 230 also comprises an annular end surface 410 facing in the axial direction A, wherein a protrusion 420 is arranged on the annular end surface 410 adjacent to the central hole 231. This protrusion 420 is configured to exert a force F on the second section 310b of the hub lock nut 220 threaded portion 310, in the axial direction A, when in the mated position, thereby retaining the vehicle wheel hub 110 in position. The location of the protrusion should preferably be optimized such that it contacts the hub lock nut close to the central hole 221.

According to aspects, a wheel hub safety washer constitutes the mating component 230.

According to aspects, any of the hub lock nut or the safety washer is formed in hot-formed steel.

Certain ranges of dimensions have been found suitable for providing required values of prevailing torque on a heavy duty vehicle. According to some aspects, the external force F is configured to provide a prevailing torque of the hub lock nut assembly in dependence of the hub lock nut dimension, wherein the prevailing torque varies between 50 Nm and 230 Nm.

The skilled person may arrive at suitable dimensions for a given requirement on prevailing torque by simulation of basic experimentation, However, with reference to FIG. 6;

According to aspects, a width W2 of the second section 310b of the hub lock nut 220 threaded portion 310 in the axial direction A corresponds to between two and three times a pitch or lead of the threaded portion.

According to aspects, a width W of the annular groove 320 in the axial direction A is between 0.8 and 1.2 times a pitch or lead of the threaded portion 310, and preferably 1.0 times the pitch or lead of the threaded portion 310.

According to aspects, a depth D of the annular groove 320 is between 5 mm and 10 mm.

According to aspects, the protrusion 420 extends annually around the whole annular end surface 410 of the mating component 230.

According to aspects, the protrusion 420 has a rounded cross-section shape or a rectangular cross-section shape.

According to aspects, any of the hub lock nut 220 and the mating component 230 is integrally formed by hot-formed steel.

It is appreciated that the different parts of the hub lock nut assemblies are also disclosed herein separately. Thus, there is disclosed herein a hub lock nut 220 for retaining a vehicle wheel hub 110 in position, the hub lock nut 220 being arranged to be mated with a mating component 230 in a mated position. The hub lock nut 220 comprises a circumferential inner wall 321 defining a central hole 221. Notably, the inner wall 321 has a threaded portion 310 separated into a first section 310a and a second section 310b by an annular groove 320 in the threaded portion 310, thereby configuring the second section 310b as a resilient portion arranged to flex with respect to the first section 310a in an axial direction A.

This hub lock nut may, according to aspects, have the dimensions discussed above in connection to FIG. 6.

There is also disclosed herein a safety washer 230 for retaining a vehicle wheel hub 110 in position, the safety washer 230 being arranged to be mated with a hub lock nut 220 in a mated position, the safety washer 230 comprising an inner wall 430 defining a central hole 231 extending in an axial direction A. Notably, the safety washer 230 comprises an annular end surface 410 facing in the axial direction A, wherein a protrusion 420 is arranged on the annular end surface 410 adjacent to the central hole 231, the protrusion 420 being 30 configured to exert a force F on the second section 310b of the hub lock nut 220 threaded portion 310, in the axial direction A, when in the mated position.

1. A hub lock nut assembly for retaining a vehicle wheel hub in position, the hub lock nut assembly comprising:
a hub lock nut comprising a circumferential inner wall defining a central hole, the inner wall having a threaded portion separated into a first section and a second section by an annular groove in the threaded portion, thereby configuring the second section as a resilient portion arranged to flex with respect to the first section in an axial direction,
a mating component with which the hub lock nut is arranged to be mated in a mated position, the mating component comprising:
an inner wall defining a central hole extending in the axial direction and corresponding to the central hole of the hub lock nut,
an annular end surface facing in the axial direction,
a protrusion is arranged on the annular end surface, the protrusion being configured to exert a force on the second section of the hub lock nut threaded portion, in the axial direction when in the mated position, thereby retaining the vehicle wheel hub in position.

2. The hub lock nut assembly of claim 1, wherein a width of the second section of the hub lock nut threaded portion in the axial direction corresponds to between two and three times a pitch or lead of the threaded portion.

3. The hub lock nut assembly of claim 1, wherein a width of the annular groove in the axial direction is between 0.8 and 1.2 times a pitch or lead of the threaded portion.

4. The hub lock nut assembly of claim 1, wherein a depth of the annular groove is between 5 mm and 10 mm.

5. The hub lock nut assembly of claim 1, wherein a wheel hub safety washer comprises the mating component.

6. The hub lock nut assembly of claim 1, wherein the protrusion extends annually around the whole annular end surface of the mating component.

7. The hub lock nut assembly of claim 1, wherein the external force is configured to provide a prevailing torque of the hub lock nut assembly in dependence of the hub lock nut dimension, wherein the prevailing torque varies between 50 Nm and 230 Nm.

8. The hub lock nut assembly of claim 1, wherein at least a portion of the hub lock nut and the mating component is integrally formed by hot-formed steel.

9. (canceled)

10. A hub lock nut for retaining a vehicle wheel hub in position, the hub lock nut being arranged to be mated with a mating component in a mated position,
the hub lock nut comprising a circumferential inner wall defining a central hole, wherein the inner wall has a threaded portion separated into a first section and a second section by an annular groove in the threaded portion, thereby configuring the second section as a resilient portion arranged to flex with respect to the first section in an axial direction.

11. The hub lock nut of claim 10, wherein a width of the second section of the hub lock nut threaded portion in the axial direction corresponds to between two and three times a pitch or lead of the threaded portion.

12. The hub lock nut of claim 10, wherein a width of the annular groove in the axial direction is between 0.8 and 1.2 times a pitch or lead of the threaded portion.

13. The hub lock nut of claim 10, wherein a depth of the annular groove is between 5 mm and 10 mm.

14. A safety washer for retaining a vehicle wheel hub in position, the safety washer being arranged to be mated with a hub lock nut in a mated position, the safety washer comprising:
an inner wall defining a central hole extending in an axial direction,
an annular end surface facing in the axial direction,
a protrusion arranged on the annular end surface, the protrusion being configured to exert a force on a threaded portion of a section of the hub lock nut, in the axial direction, when in the mated position.

15. The safety washer of claim 14, wherein the external force is configured to provide a prevailing torque of a hub lock nut assembly comprising the hub lock nut in dependence of the hub lock nut dimension, wherein the prevailing torque varies between 50 Nm and 230 Nm.
